(19) United States
(12) Patent Application Publication
(10) Pub. No.: US 2022/0122089 A1
(43) Pub. Date: Apr. 21, 2022

(54) SECURE GIFTING SYSTEM TO REDUCE FRAUD

(71) Applicant: ALTRÜUS, INC., Austin, TX (US)

(72) Inventors: Francisco Bonilla Kuhlmann, Austin, TX (US); Iurii Teslenko, Kharkiv Oblast (UA); Roman Nikitin, Kharkiv Oblast (UA)

(21) Appl. No.: 17/071,552

(22) Filed: Oct. 15, 2020

(51) Int. Cl. G06Q 30/00; G06K 7/14

(52) U.S. Cl. CPC G06Q 30/0185; G06K 7/1417; G06K 7/1413

(57) ABSTRACT

As an example, a computing device may be used to open a software application associated with a gifting platform and select a particular gift entitlement from one or more gift entitlements available for redemption. The computing device may be used to scan a merchant identifier code identifying a merchant associated with the gift entitlement and send a redemption message to the gifting platform. The gifting platform may send a redemption update message to the computing device that includes a secret symbol. The computing device may generate a timestamp and display the secret symbol and the timestamp to enable an employee of the merchant to verify the timestamp and the secret symbol and provide a gift corresponding to the gift entitlement. For example, the gift may be goods, services, or both.

### BACKGROUND OF THE INVENTION

### Field of the Invention

This invention relates generally to computing devices and, more particularly to a system to provide secure redemption of a gift or a purchase.

### Description of the Related Art

Hundreds of billions of dollars in gift cards are sold every year. Gift cards are prime targets for scammers because they are relatively untraceable and have few safeguards, unlike a credit card. In addition, gift card fraud may leave merchants open to costly chargebacks from the credit cards that were originally used to purchase the gift cards. Furthermore, systems in which a user makes a purchase at a first location (e.g., in a store) and then takes delivery at a second location (e.g., warehouse operated by the store) may be prone to exploitation by scammers.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

As an example, a computing device may be used to open a software application associated with a gifting platform and select a particular gift entitlement from one or more gift entitlements available for redemption. The computing device may be used to scan a merchant identifier code identifying a merchant associated with the gift entitlement and send a redemption message to the gifting platform. The gifting platform may send a redemption update message to the computing device that includes a secret symbol. The computing device may generate a timestamp and display the secret symbol and the timestamp to enable an employee of the merchant to verify the timestamp and the secret symbol and provide a gift corresponding to the gift entitlement. For example, the gift may be goods, services, or both.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a merchant device to create a gift catalog, according to some embodiments.

FIG. 2 is a block diagram of a system that includes a sender device that is used to send a gift notification to a recipient device, according to some embodiments.

FIG. 3 is a block diagram of a system that includes a recipient device used to redeem a gift entitlement from a sender, according to some embodiments.

FIG. 4 is a block diagram of a user interface that includes a feed that includes posts identifying a description of a gift, and a sender and a recipient of the gift, according to some embodiments.

FIG. 5 is a flowchart of a process that includes creating a catalog, according to some embodiments.

FIG. 6 is a flowchart of a process that includes selecting a gift and creating an associated message, according to some embodiments.

FIG. 7 is a flowchart of a process that includes scanning a merchant identifier code to redeem to the recipient notification, according to some embodiments.

FIG. 8 illustrates an example configuration of a computing device that can be used to implement the systems and techniques described herein.

### DETAILED DESCRIPTION

The systems and techniques described herein enable a sender to select a recipient, select a merchant, browser the merchant's catalog, select a gift described in the catalog, create a message (e.g., text, audio, video, or any combination thereof) for the recipient, and send an entitlement to the gift and the message to the recipient. The gift may be a gift card for a particular amount in particular currency (e.g., $5, $10, $15, or the like). The gift may be a product (e.g., food item, beverage item, flowers, or the like), a service (e.g., a massage, a facial, a manicure, a pedicure, a carwash, or the like), or a combination of both (e.g., an oil change that includes products such as new oil and a service that includes replacing existing oil with the new oil).

The app may enable the recipient to create the message, e.g., enter a text message, record an audio message, record a video message, or the like. The details associated with such a transaction, (e.g., the sender, the recipient, and details regarding the gift) may be posted on one or more social media sites. For example, an application (“app”) that the sender downloads and installs on the sender's device (e.g., mobile phone, tablet, or the like) may enable the sender to browse the merchant's catalog, select the gift from the catalog, create the message, and send (i) an entitlement to the gift and (ii) the message to the recipient. The recipient may, for example, be a friend or a relative of the sender. The app may include a social media component in which a feed displays posts, including a post indicating that the sender sent the gift to the recipient. The post may include information about the gift and, a reason (e.g., a gesture of appreciation) or an event (e.g., birthday, promotion, engagement, or the like) associated with the gift. For example, a post may indicate that Bob sent Jane an entitlement redeemable for a food (e.g., pastry, sandwich, pizza, or the like) or beverage item (e.g., coffee, latte, or the like) at a particular restaurant on Jane's birthday, to congratulate Jane on her promotion, to thank Jane for her assistance, or the like. Such a post may be seen by other friends and relatives of Jane who may, in response to viewing the post, send an entitlement to a gift to Jane.

The sender may specify whether the sender's message to the recipient is either viewable by others or not viewable by others. For example, if the sender's message includes content that the sender is comfortable with others viewing or playing back, then the sender may specify that the sender's message is viewable by others. If the sender's message includes content that is of a private nature or other content that the sender is uncomfortable with others viewing or playing back, then the sender may specify that the sender's message is not viewable by others.

After the sender selects the recipient using the app, the app may communicate with the server to automatically display businesses that have created catalogs (e.g., stored on the server) and that are within a predetermined distance (e.g., 5 miles, 10 miles, or the like) from the recipient to enable the recipient to visit the business to redeem the entitlement or to have the entitlement delivered to the recipient's home (or other location). The app may provide a default predetermined distance that the sender can override. In some cases, the sender may create a preferences file in the sender's app that specifies the predetermined distance. The app may enable members (e.g., users that have created an account with the app) to create one or more wish lists that are stored on the server. If the wish list is associated with a particular occasion, such as a wedding, the wish list may function as a gift registry. For example, if a sender desires to send a gift entitlement to a recipient, and the sender is unsure as to what type of gift entitlement the recipient would appreciate, the sender may view (using the app) a wish list created by the recipient. In this way, the sender can select a gift entitlement that the recipient is likely to appreciate. The wish list may span multiple merchants. For example, the wish list may include a first subset of items from a catalog of merchant X, a second subset of items from a catalog of merchant Y, a third subset of items from a catalog of merchant Z, and so on. In this way, the wish list may include a variety of items from multiple merchants.

In addition to information about a gift given by a sender to a recipient being posted in a feed of the app, the sender may specify one or more additional social media sites (e.g., Facebook®, Instagram®, Twitter®, LinkedIn®, or the like) where the information is to be posted. In some cases, each member that has created an account with the app may specify in settings stored in a preferences file whether to automatically (e.g., without human interaction) post on one or more social media sites and, if so, specify on which social media sites to post. The app may enable the sender to override the settings in the preferences file.

After a sender selects a recipient, a gift entitlement, and creates a message, the sender may provide payment information (e.g., credit card number, bank account number or the like) to purchase the gift associated with the gift entitlement. The server may process the payment information and keep track of the sender, the recipient, the gift entitlement and an amount (e.g., dollar amount) associated with the gift. After the recipient's payment for the gift is processed, the merchant may receive a portion of the payment. The company operating the server may take a portion (e.g., no more than 10%) of the payment.

The sender may use the app to send the gift entitlement and the message to the recipient. Information about the gift, the sender, the recipient, along with the message may be posted on one or more social media sites. Posting this information may enable others to see the post and respond. For example, if user A sends user B a gift entitlement on user B's birthday (or another occasion), then other friends and/or relatives of user B may view the post (e.g., indicating that user A gave user B a gift entitlement on a particular occasion) and determine that they too should send user B a gift entitlement. As another example, if user A sends user B a gift entitlement because user B got promoted, then other friends and/or relatives of user B may view the post (e.g., indicating that user A gave user B a gift entitlement to congratulate user B) and determine that they too should send user B a gift entitlement. In this way, the initial post may cause a swarm of other posts to be generated.

The recipient may receive a notification message that the sender has sent the recipient a gift entitlement. If the recipient does not have an app installed, the notification message may provide information (e.g., a link or the like) on how to download and install the app. After installing and opening the app, the app may display the gift entitlement, the sender, and enable the recipient to playback the sender's message (e.g., video, audio, text, or any combination thereof). If the recipient already has the app installed on a device (e.g., phone, tablet, or other computing device) before the recipient receives the notification message, then receiving the notification message may cause the device to automatically (e.g., without human interaction) open the app and display the notification message, including the name of the sender, a description of the gift entitlement (e.g., one latte at Coffee & More, a medium 3-topping pizza at Mario's Pizza, or the like), and enable playback of the sender's message. After playing back the sender's message, the app may enable the recipient to record a message in response. The app may automatically send the recipient's message to the sender and automatically post the recipient's message on the one or more social media sites. In this way, the app enables not just gift giving but a social media platform designed for gift giving and sharing details about the gift giving.

To redeem the gift entitlement, the recipient may go to a location of the merchant associated with the gift or place a delivery order with the merchant to have the gift delivered. At the merchant location, the recipient may use the app to scan a merchant identifier code, such as a quick response (QR) or another type of scannable code. For a delivery order, the recipient may use the app to scan a merchant identifier code located on a package (e.g., pizza box, paper bag, or the like) used to deliver the gift. Scanning the merchant identifier code may cause the app to send a redemption request to a server associated with the app. The redemption request may include the merchant identifier code and device data uniquely identifying the device used to scan the merchant identifier code. For example, the device data may include an Internet Protocol (IP) address, a media access control (MAC) address, an International Mobile Equipment Identity (IMEI) number, or another device identifier that uniquely identifies the device (e.g., smart phone or tablet) executing the app. The server may verify that the recipient received a gift entitlement to a gift associated with the merchant identified by the merchant identifier code. If the server confirms that the recipient does not have a gift entitlement associated with the merchant, the server may provide an error message indicating this information to the recipient. If the server confirms that the recipient received a gift entitlement to a gift associated with the merchant, the server may modify a status of the gift entitlement. For example, the server may change the status of the gift entitlement from unredeemed to redeemed. The server may send a redemption update message to the app on the recipient's device. The redemption update message may update the status of the gift entitlement in the app to indicate the redemption. The redemption update message may include a secret symbol associated with the merchant. The merchant may specify how frequently the secret symbol is changed. For example, the server may change the secret symbol by randomly selecting a new secret symbol after a predetermined time interval (e.g., N days, N>0, typically 6<N<32) has elapsed. The secret symbol may be randomly chosen from among hundreds of symbols. The secret symbol may be a graphical icon, such as an emoji.

After receiving the redemption update message, the app may create a timestamp based on a time at which the redemption update message was received. The recipient may use the app to display the secret symbol and the timestamp to an employee of the merchant. The employee of the merchant may verify whether the secret symbol is the correct secret symbol during the current time interval (e.g., current week, current month, or the like). If the employee determines that the secret symbol is correct and the timestamp is within a predetermined time interval (e.g., 5, 10, 15 or the like minutes) of a current time, then the employee may provide the gift associated with the gift entitlement to the recipient. If the employee determines that the secret symbol is incorrect or that the current time is more than a predetermined time interval after the timestamp, then the employee may not provide the gift associated with the gift entitlement to the recipient.

There are several advantages of the systems and techniques described herein. First, gift entitlements can be exchanged between people with a reduced possibility of fraud as compared to traditional gift cards. Second, posting details about a gift to a recipient encourages additional users to send additional gifts to the recipient, driving additional gift giving in a way that traditional gift cards do not do. Third, the merchant does not have to do much to redeem a gift entitlement. The merchant merely makes the merchant identifier code available for scanning and lets employees know the current secret symbol and the time period that a recipient has after the redemption is timestamped to complete the redemption process. The app and server are used to keep track of the gift giving and redemption process. Fourth, a merchant may generate traffic into stores by sending gift entitlements to selected customers. For example, a coffee bar may launch a new beverage (e.g., spiced pumpkin latte). To bring awareness of the new beverage to customers, the merchant may send gift entitlements to the new beverage to particular customers, e.g., customers that meet particular criteria, such as, for example, living (or working) within a predetermined distance from a location of the merchant, spending at least a predetermined amount of money on average at one or more locations in the last M months (M>0), or other criteria. Fifth, celebrities may create contests for social media followers and reward some of their followers by providing them with the gift entitlement. For example, a celebrity that has signed a contract to represent a line of cosmetics may offer a contest on social media to enable followers to win entitlements to a cosmetic in the line of cosmetics.

In addition, the systems and techniques described herein may be used for other purposes. For example, many retailers keep a single item out on the store floor and when a customer purchases the item, the customer goes to an inventory warehouse to obtain the item. In such a situation, the sender and the recipient may be the same person. For example, while browsing a retail store, a customer may use the app to scan a barcode of an item they wish to purchase, enter payment information, and purchase an entitlement to the item. In response to the purchase, the customer may receive a notification message that the entitlement to the item was purchased. The customer may go to the inventory warehouse, scan the merchant identifier code (e.g., QR code), receive a secret symbol, and display the secret symbol and the timestamp to an employee. After verifying the secret symbol and the difference between the current time in the timestamp, the employee may provide the item to the customer.

As an example, a computing device may include one or more processors and one or more non-transitory computer-readable storage media to store instructions executable by the one or more processors to perform various operations. For example, the operations may include receiving a gift notification message from a gifting platform indicating that a user of the computing device has received a gift entitlement from a sender. The gift entitlement is selected by the sender from (i) a wishlist created by a user of the computing device, where the wishlist is stored in an account of the user on the gifting platform or (ii) a merchant catalog created by a merchant, where the merchant catalog is stored in a merchant account of the merchant on the gifting platform. The merchant may be selected by the gifting platform in part based on a proximity of at least one location of the merchant to the user of the computing device. The operations may include determining that the software application is not installed on the computing device, automatically downloading the software application, and automatically installing the software application on the computing device. Receiving the git notification message from the gifting platform may cause the computing device to automatically open the software application, and automatically select a link in the gift notification message to display a post on a social media site. The post may include a sender name of the sender of the gift entitlement, a recipient name of the user of the computing device, a description of the gift entitlement, and a sender message created by the sender. The application may automatically playing back the sender message. The sender message may include at least one of: a video-based message, an audio-based message, or a text-based message.

The computing device may initiate execution of the software application associated with the gifting platform and receive a selection of a particular gift entitlement from one or more gift entitlements available for redemption. If the gift entitlement comprises a gift card, selecting the particular gift entitlement includes: selecting the gift card entitlement, and receiving a redemption amount. The computing device may scan a merchant identifier code that uniquely identifies a merchant associated with the gift entitlement and send a redemption message to the gifting platform. For example, the merchant identifier code may be a quick response (QR) code. The redemption message may include: a recipient identifier identifying a recipient of the particular gift entitlement, a gift identifier identifying the particular gift entitlement, and a device identifier that uniquely identifies the computing device. For example, the device identifier may include one of: (i) an International Mobile Equipment Identity (IMEI) number, (ii) a media access control (MAC) address, or (iii) a serial number. The computing device may receive a redemption update message from the gifting platform. In response to receiving the redemption update message from the gifting platform, the computing device may update a status of the particular gift entitlement from unredeemed to one of redeemed or partially redeemed If the gift entitlement comprises a gift card, the redemption update message may cause the computing device to update a remaining balance of the gift card by deducting the redemption amount from a current balance of the gift card. The redemption update message may include a secret symbol. The secret symbol is selected by the merchant and is associated with the merchant for a predetermined period of time specified by the merchant. The computing device may generate a timestamp that includes a current time and date and display, on a display device of the computing device, the secret symbol and the timestamp to enable an employee of a merchant associated with the particular gift entitlement to verify the secret symbol and the timestamp and provide a gift corresponding to the gift entitlement. The software application may display a feed from a social media site associated with the gifting platform.

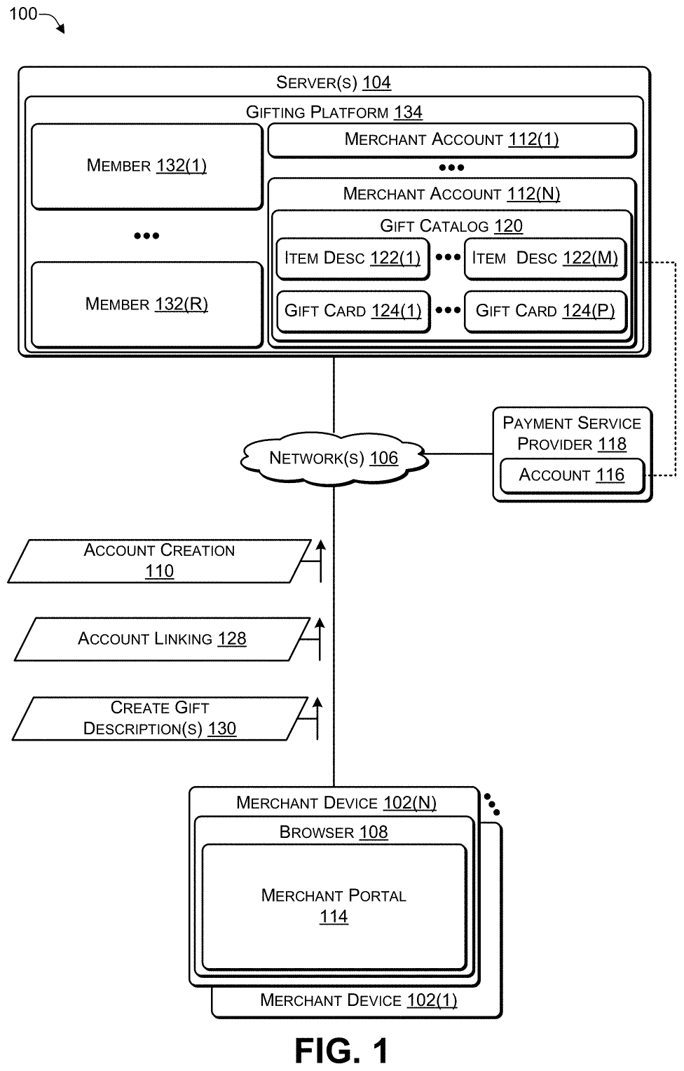

FIG. 1 is a block diagram of a system 100 that includes a merchant device to create a gift catalog, according to some embodiments. The system 100 may include one or more merchant devices, such as a merchant device 102(1) to a merchant device 102(N) (N>0), connected to one or more servers 104 via one or more networks 106. For example, the servers 104 may be used by a cloud hosting service.

Each of the merchant devices 102 may be a computing device, such as, for example, a desktop computing device, a laptop computing device, a tablet, a smart phone, or another type of computing device. A merchant may use a merchant device, such as the merchant device 102(N), to access a gifting platform 134 that is hosted by the server 104. For example, the merchant may use the merchant device 102(N) to open a browser 108 and send an account creation message 110 to the server 104 to create a merchant account 112(N). The server may include multiple merchant accounts 112, with the merchant account 112(1) corresponding to a first merchant and the merchant account 112(N) corresponding to an Nth merchant.

After creating the merchant account 112(N), the merchant may open a merchant portal 114 that is accessed via the browser 108 to access the merchant account 112(N) and create gift description(s) 130 to create a gift catalog 120. The gift catalog 120 may describe various items available for gifting via the gifting platform 134. For example, the merchant may create descriptions of multiple items, such as an item description 122(1) to an item description 122(M) (M>0), that are available for gifting. For example, the item descriptions 122 may include descriptions of products (e.g., food items, beverage items, goods or the like), services (e.g., massage session, yoga class, or the like), or both (e.g., an oil change that may include both products, such as oil and an oil filter, along with a service, to replace the oil and oil filter). The item descriptions 122 may include a price of each item. The merchant may create gift cards 124(1) to 124(P) (P>0) in different amounts, such as, for example, $5, $10, $15, $25, $50, $100, or the like. The gift cards 124 may be in a particular currency. The gifting platform 134 may enable a sender in a first country (e.g., United States of America) to send a gift card to a recipient in a second country (e.g., Mexico) in a currency associated with the second country (e.g., Mexican Pesos) or associated with the first country (e.g., U.S. Dollars).

The merchant may use the merchant portal 114 to perform account linking 128 to link the merchant account 112(N) with an account 116 associated with the merchant at a payment service provider 118 (e.g., Square®, Stripe®, or the like). When a sender initiates a purchase of one of the items 122 or gift cards 124 in the gift catalog 120, the sender may provide payment information (e.g., a credit card, debit card, bank account information, or other financial account information). The payment information may be sent to the payment service provider 118 and processed, e.g., in which the payment service provider 118 deposits at least a portion of the payment for the gift deposited into the merchant's account 116. The payment service provider 118 may charge a fee, such as a flat fee, or a percentage of the transaction (e.g., 3%, 4%, 5%, 6%, 7%, 8%, or the like) for processing the payment and making the deposit.

The gifting platform 134 may include multiple members 132(1) to 132(R). Each of the members 132 may be individuals that have created an account with the gifting platform 134 to enable each individual to send and receive gifts available on the gifting platform 134. For example, the member 132(1) may select an item description 122 or gift card 124 from the gift catalog 120 and send the selection to another member, such as the member 132(R). If a member 132 sends a gift entitlement (e.g., item description 122 or gift card 124) to a recipient who is not currently a member of the gifting platform 134, the recipient may receive a notification message that includes a link and instructions to become a member of the gifting platform 134 in order to claim the gift entitlement.

Thus, a merchant may create an account on a gifting platform hosted by a server (or hosted by a cloud service) and create a gift catalog of items (e.g., products and/or services) available for gifting. The gift catalog may include a description of each item available for gifting and each gift card may identify a currency and an amount of the currency of the gift card. The redemption mechanism (as described herein) used by the gifting platform may reduce the amount of fraud as compared to conventional gift cards.

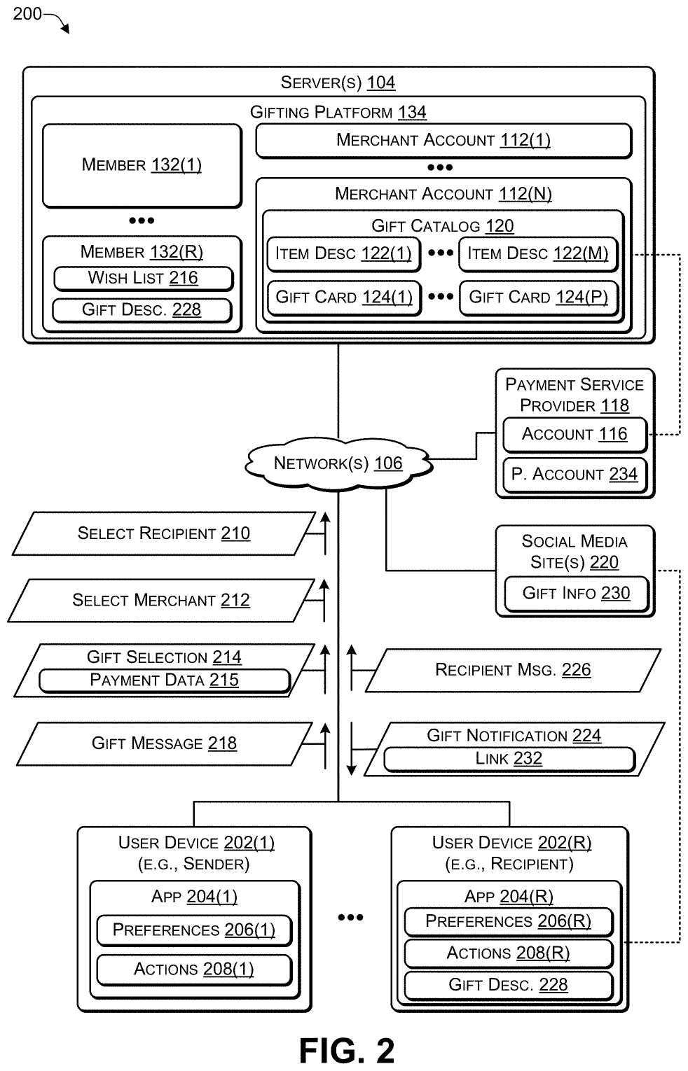

FIG. 2 is a block diagram of a system 200 that includes a sender device that is used to send a gift notification to a recipient device, according to some embodiments. The system 200 may include multiple user devices, such as a user device 202(1) to a user device 202(R) (R>0) connected to the server 104 via the networks 106. The server 104 may host the gifting platform 134 that includes multiple merchant accounts 112, with each merchant account including a gift catalog 120. The gifting platform 134 may include multiple members 132 that have created accounts to become members of the gifting platform 134.

In the example illustrated in FIG. 2, user device 202(1) is used by a sender to send a gift entitlement to a recipient associated with a user device 202(R). The user devices 202 may be a desktop computing device, laptop computing device, a tablet computing device, a smart phone, or another type of computing device. Typically, the user devices 202 may be a tablet or a smart phone.

An application (“app”) 204(1) may be installed on the user device 202(1). The app 204(1) may enable a user (“sender”) of the user device 202(1) to specify preferences stored in a preferences file 206(1). For example, the preferences 206(1) may include account information (e.g., credit card, debit card, bank account number, or the like) used to pay for gift items purchased from the merchant accounts 112 using the app 204(1). The preferences 206(1) may identify whether the sender prefers social media messages to be posted publicly and on which social media sites to post. The preferences 206(1) may include other preferences of the user as described herein.

The app 204(1) may enable the user of the user device 202(1) to perform various actions 208(1) to interact with the gifting platform 134. For example, the user of the user device 202(1) may use the app 204(1) to select a recipient of a gift. After selecting the recipient (e.g., a user associated with the user device 202(R)), the app 204(1) may display merchants that meet criteria specified in the preferences 206(1). For example, the app 204(1) may display merchants that the recipient frequents, merchants within a predetermined distance from where the recipient lives and/or works, merchants located within the same city as the recipient, or merchants that satisfy other criteria. The predetermined distance may be specified in the preferences 206(1). The sender may use the app 204(1) to select a merchant 212 from among the merchants displayed by the app 204(1). After selecting a merchant, such as the merchant associated with the merchant account 112 (N), the sender may use the app 204(1) to browse the gift catalog 120 in the merchant account 112(N) and make a gift selection 214 of one or more gifts. If the recipient is a member (e.g. member 132(R) of the gifting platform 134) and has created a wish list 216, then the sender may use the app 204 to browse the wish list 216 of the member 132(R) and make the gift selection 214 from the wish list 216. After selecting one or more of the gifts from the gift catalog 120 and/or the wish list 216, the sender may provide payment data 215, such as a credit card number, a debit card number, a bank account number, or other payment information.

The gifting platform 134 may enable multiple senders to chip in to send a single gift to a recipient. For example, if the wish list 216 is a type of registry (e.g., wedding registry), then the gifting platform 134 may enable each of multiple senders to purchase a portion of a particular gift. To illustrate, for a relatively expensive gift, each sender may pay a portion of a purchase price of a particular gift until the entire purchase price has been satisfied. For example, a first sender may pay 50%, a second sender may pay 30%, and a third sender may pay 20% of the purchase price of a gift.

After the sender has made the gift selection 214 and provided the payment data 215, the app 204(1) may prompt the sender to record and send a gift message 218 to the recipient. The gift message 218 may be a video file, an image file (e.g., photo), an audio file, a text file, or any combination thereof. For example, the gift message 218 may include a personalized message to the recipient, such as, for example, “Happy birthday”, “Congratulations on your promotion”, “Congratulations on your engagement”, or the like. In the case of multiple senders purchasing a single gift, each sender may record a gift message to the recipient.

The gifting platform 134 may receive the gift selection 214 and the payment data 215, process the payment data 215, and send a gift notification 224 to the user device 202(R) associated with the recipient. For example, the gifting platform 134 may receive the gift selection 214 and associate a gift description 228 of the gift with the recipient, e.g., member 132(R). In this way, the gifting platform 134 keeps track of which gifts are associated with (e.g., have been given to) each of the members 132. After receiving the payment data 215, the gifting platform 134 may send the payment data 215 to the payment service provider 118. The payment service provider 118 may deposit at least a portion of the payment for the selected gift into the account 116 associated with the merchant account 112(N) from which the gift was selected. The payment service provider 118 may take a portion (e.g., X %, 0<X<=10) of the payment as a fee for processing the transaction. In addition, the payment service provider 118 may take a portion (e.g., Y %, 0<Y<=10) of the payment for the selected gift and deposit the portion into a platform account 234 associated with the gifting platform 134. The gifting platform 134 may be paid a portion of the payment for the selected gift and the portion may be paid by a particular merchant from their corresponding merchant account 112 or the sender may be charged a fee. For example, assume the gifting platform takes 5% of the transaction and the payment service provider takes 3%. If the user device 202(1) sends a $100 gift card to the user device 202(R), then, in some cases (e.g., the gifting platform 134 is paid by the merchant), the sender pays $100, $92 is deposited into the merchant account 116, $5 is deposited into the gifting platform account 234, and the payment service provider keeps $3. In other cases (e.g., the gifting platform 134 is paid by the sender), the sender pays $105, $97 is deposited into the merchant account 116, $5 is deposited into the gifting platform account 234, and the payment service provider keeps $3.

The gifting platform 134 may automatically post gift information 230 on one or more social media sites 220. For example, the gift information 230 may include a name of the recipient, a name of the sender, the gift description 228, the gift message 218, a date and/or time when a gift notification 224 was sent to the user device 202(R) of the recipient, an occasion (e.g., birthday, promotion, engagement, or the like) or other reason why the recipient received the gift, other gift-related information, or any combination thereof. The posting of the gift information 230 on one or more social media sites 220 may spur others, including other members 132, to send the recipient a gift. For example, the post of the gift information 230 may notify others of the particular occasion and notify others of the gift provided by the sender, thereby motivating others to join in the gift giving. One of the social media sites 220 may include each of the apps 204, which have may have a social media feed provided by the gifting platform 134. The social media sites 220 may include other sites, such as, for example, Facebook, Instagram, LinkedIn, and the like. People who are friends or relatives of the recipient who are not currently members of the gifting platform 134 and who view the gift information 230 on other social media sites may join (e.g., become members of) the gifting platform 134 by downloading and installing the app 204. Thus, the gift information 230 posted on other social media sites (e.g., other than the social media portion of the app 204) may drive people to become members of the gifting platform 134 to enable them to send a gift to the recipient and have information about their generosity posted on the social media sites 220.

The gifting platform 134 may send a gift notification 224 to the user device 202(R) to notify the recipient that the sender has sent the recipient a particular gift. If the recipient is one of the members 132 of the gifting platform 134, then the gift notification 224 may be displayed in the app 204(R). Based on the preferences 206(R), in response to the user device 202(R) receiving the gift notification 224, the user device 202 (R) may automatically launch the app 204(R) and display the gift notification 224 in the app 204(R). For example, the recipient may set one of the preferences 206(R) to automatically launch the app 204(R) in response to the user device 202(R) receiving a gift notification message, such as the gift notification 224. The gift notification 224 may include a link 232 to access the gift info 230, including the gift message 218. By selecting the link 232, the recipient may view the gift information 230 including viewing the name of the sender(s), information about the gift, and the gift message 218 recorded by the sender. The app 204(R) may enable the recipient to respond to the gift information 230 by recording a recipient message 226 (e.g., a video message, an image file (e.g., photo), an audio message, a text message, or any combination thereof). The app 204(R) may automatically post the recipient message 226 on the social media sites 220. In addition, the sender(s) may receive the recipient message 226 or a link to access the recipient message 226 on one or more of the social media sites 220. For example, the recipient message 226 may be posted on the feed of the app 204(1) and the sender may play back the recipient message 226 using the app 204.

If the recipient is not one of the members 132 of the gifting platform 134, then the gift notification 224 may be in the form of a text message, an email, or another type of notification message and the link 232 may provide access to information indicating how to download and install the app 204 to access the gifting platform 134. In this way, a sender who sends a gift to a non-member may cause non-member to become a member of the gifting platform 134 to access the gift sent by the sender. In some cases, the gifting platform 134 may offer a referral bonus (e.g., $5 or the like) to the sender for causing a non-member to become a member of the gifting platform 134.

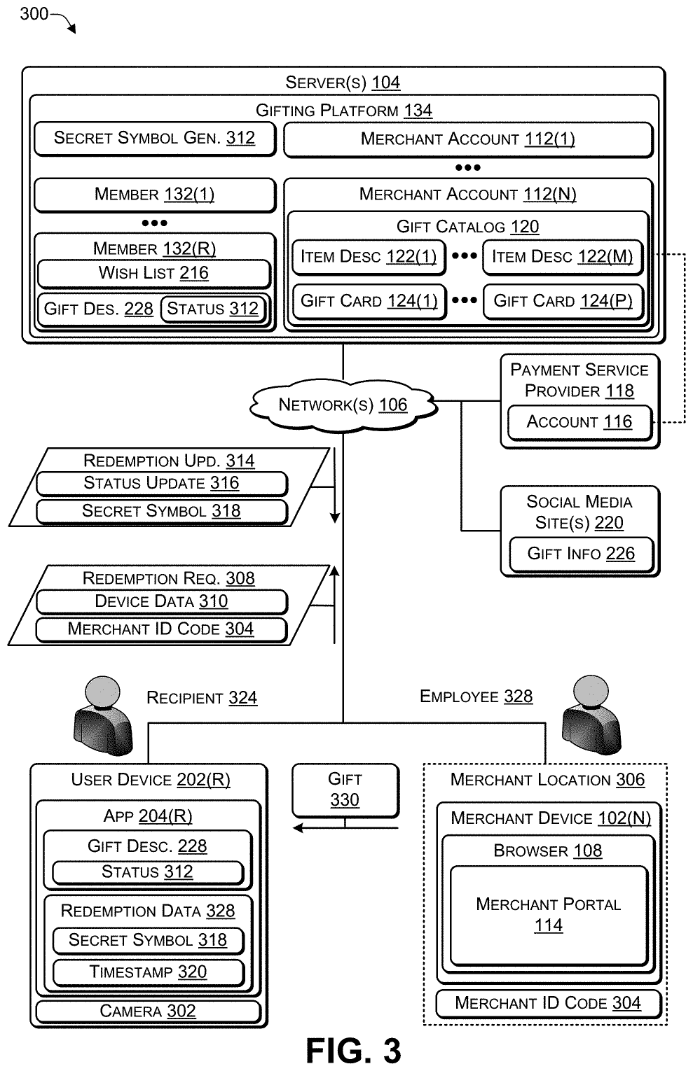

At this point, the recipient has an entitlement (e.g., gift description 228) to a gift sent by the sender in that the recipient's member account 132(R). The recipient may redeem the entitlement using the app 204(R), as described in more detail in FIG. 3.

Thus, sender(s) may use an app to access a gifting platform that includes multiple members and multiple merchant accounts with each merchant account having a catalog of gifts. The sender(s) may select a recipient and, based on information associated with the recipient, the gifting platform may display one or more merchants that have gifts that are accessible to the recipient. Alternately, the sender(s) may view a wish list (or registry) created by the recipient, if available. The wish list may include items selected from multiple merchant gift catalogs. After selecting the recipient and the gift, the sender(s) may provide payment information to pay for the gift. The sender(s) may record a gift message for the recipient. After the gifting platform receives the gift selection and payment information, the gifting platform may process the payment information using a payment service provider that deposits at least a portion of the payment for the gift into an account associated with the merchant from which the gift is purchased. The gifting platform may post information about the gift, including the sender(s), the recipient, the gift message(s), and information about the gift on one or more social media sites. The gifting platform may send a gift notification to a device associated with the recipient. If the recipient is not a member of the gifting platform, the gift notification may be in the form of a text or an email and may include a link to enable the recipient to download and install the app and create an account with the gifting platform to access the gift. After receiving the gift notification, the app may enable the recipient to record a recipient message to the sender. The recipient message to the sender may be posted on one or more social media sites as a follow-up to the original post (e.g., describing the sender sending the gift to the recipient). The app may enable the sender, the recipient, and others who can view the original post to add additional comments to the original post.

FIG. 3 is a block diagram of a system 300 that includes a recipient device used to redeem a gift entitlement from a sender, according to some embodiments. After receiving the gift notification 224 of FIG. 2 indicating that a recipient 324 has received an entitlement to a gift from a sender, the recipient 324 may open the app 204(R) and use a camera 302 (or another type of imaging device) of the user device 202(R) to scan a merchant identifier (ID) code 304 associated with a merchant. In some cases, as illustrated in FIG. 3, the merchant ID code 304 may be displayed at a merchant location 306. In other cases, the merchant ID code 304 may be displayed on a packaging of a delivery being made to the recipient 324.

The recipient 324 may open the app 204(R), select a particular gift entitlement (e.g. the gift description 228) that the recipient desires to redeem, and use the camera 302 to scan the merchant ID code 304. In response to the scan of the merchant ID code 304, the app 204(R) may automatically send a redemption request 308 to the gifting platform 134. The redemption request 308 may include the merchant ID code 304 and device data 310. In some cases, the redemption request 308 may include the gift description 228 to identify which gift entitlement is being redeemed. The device data 310 may uniquely identify the user device 202(R). For example, the device data 310 may be an International Mobile Equipment Identity (IMEI), a media access control (MAC) identifier, a serial number, a service tag, or another type of identifier that uniquely identifies the user device 202(R). The device data 202(R) may include membership data that uniquely identifies the recipient 324 as a particular member, such as the member 132(R) of the gifting platform 134. The device data 202(R) may be recorded by the gifting platform 134 to prevent fraud.

The gifting platform 134 may receive the redemption request 308, determine the member account 132(R) associated with the device data 310, and determine whether the member 132(R) has an entitlement, such as the gift description 228, to a gift provided by a merchant identified by the merchant ID code 304. If the gifting platform 134 determines that the member 132(R) has an entitlement to a gift provided by the merchant identified by the merchant ID code 304, then the gifting platform 134 may check a status 312 of the gift entitlement (e.g., the gift description 228) to determine whether the status 312 is redeemed, unredeemed, or partially redeemed (e.g., in the case of a gift card). If the gifting platform 134 determines that the status 312 is unredeemed or partially redeemed, then the gifting platform 134 may modify the status 312. For example, if the status was unredeemed, the gifting platform 134 may modify the status 312 to redeemed. The gifting platform 134 may send a redemption update message 314 to the user device 202(R). The redemption update message 314 may include a status update 316 reflecting the modified status 312, e.g., the change from unredeemed to redeemed, and a secret symbol 318. The secret symbol 318 may be randomly selected by the gifting platform 134 or selected by the merchant. The secret symbol 318 may be associated with the merchant for a particular period of time (e.g., a week, a month, or the like) specified by the merchant. For example, a first secret symbol may be associated with the merchant for a first week (or a first month), a second secret symbol may be associated with the merchant for a second week (or a second month), and so on. If the gifting platform 134 determines that the member 132(R) does not have an entitlement to a gift provided by the merchant identified by the merchant ID code 304, then the gifting platform 134 may indicate that the status 312 is “redeemed”, “unavailable”, or the like.

After user device 202(R) receives the redemption update message 314, the app 204(R) may automatically display the updated status 312 associated with the gift description 228 (e.g., gift entitlement). The app 204(R) may automatically display redemption data 328 that includes the secret symbol 318 and a timestamp 320 indicating approximately when the redemption update message 314 was received by the user device 202(R). The timestamp 320 may include a date and a time to within a minute in a format, such as, for example, MM-DD-YYYY at HH:NN AM/PM, where MM=month, DD=day, YYYY=year, HH=hour, and NN=minutes, e.g., 09-21-2020 at 7:48 PM. The recipient 324 may display the secret symbol 318 and the timestamp 322 and employee 328 of the merchant. The employee 328 may verify that the secret symbol 318 is the particular secret symbol associated with the merchant during the current time period and may verify that the timestamp 320 is within a predetermined time interval (e.g., X minutes, X>0, X typically 5, 10, 15 minutes or the like). The predetermined time interval may be specified by the merchant and may depend on how busy the merchant is and how long customers wait to receive an item. If the employee 328 verifies that the secret symbol 318 is the secret symbol associated with the merchant during the current time period and verifies that the timestamp 320 is within the predetermined time interval, then the employee 328 may provide a gift 320 corresponding to the gift description 228 (e.g., the gift entitlement) to the recipient 324. If the employee 328 determines that the secret symbol 318 is not the secret symbol associated with the merchant during the current time period or determines that the timestamp 320 is longer than the predetermined time interval, then the employee 328 may not provide the gift 320 to the recipient 324.

If the recipient 324 is redeeming a gift card, then the recipient 324 opens the app 204(R) and selects the gift card, e.g., the gift description 228, which displays how much money is in (e.g., a remaining balance of) the gift card. The recipient 324 enters a redemption amount of the gift card that is less than or equal to the remaining balance of the gift card. After the recipient 324 enters the redemption amount and selects redeem (e.g., one of the actions 208(R) of FIG. 2), the app 204(R) sends the redemption request 308 to the gifting platform 134 to verify whether the redemption amount is available. If the gifting platform 134 verifies that the redemption amount is available, the gifting platform 134 modifies the status 312 by deducting the redemption amount from the remaining balance on the gift card (gift description 228) and sends the redemption update 314 to the app 204(R). The app 204(R) displays a confirmation screen indicating the amount redeemed from the gift card, the timestamp, plus the secret symbol will appear on screen. If the gifting platform 134 determines that the redemption amount is not available, then the gifting platform 134 sends the redemption update 314 to the app 204(R) and indicates in the redemption update 314 that the remaining balance of the gift card is less than the amount the recipient 324 is attempting to redeem.

Thus, a recipient of the gift entitlement may open an app associated with a gifting platform, select the gift entitlement, and if the gift entitlement is a gift card, enter a redemption amount, and use a camera of a user device to scan a merchant ID code to initiate the redemption process. Scanning the merchant ID code may cause the app to send a redemption request to the gifting platform. The redemption request may include the merchant ID code and device data that uniquely identifies the user device. In some cases, the redemption request may include the gift description (gift entitlement). The gifting platform may receive the redemption request, identify the recipient based on the device data, and determine whether the recipient has a gift entitlement with the merchant identified by the merchant ID code. If the gifting platform determines that the recipient has a gift entitlement with the merchant, the gifting platform may modify a status of the gift entitlement to indicate that the gift entitlement has been redeemed (or partially redeemed in the case of a gift card) and send a redemption update message to the user device. The redemption update message may include a secret symbol and an update to the status of the gift entitlement. The user device may receive the redemption update message update the status of the gift entitlement to indicate that the gift entitlement has been fully (or partially) redeemed. The app may display the updated status of the gift entitlement. The app may, based on receiving the redemption update message, generate a timestamp and display the secret symbol in the timestamp. The recipient may use the user device to display the timestamp and the secret symbol to an employee of the merchant. The employee may verify that the secret symbol is associated with the merchant and determine whether the timestamp is within a predetermined time interval of the current time. After verifying the secret symbol and the timestamp, the employee may provide the gift associated with the gift entitlement to the recipient. In this way, much of the redemption process is handled by the app and the gifting platform. The merchant merely displays the merchant ID code and the merchant's employee, after verifying the secret symbol and the timestamp, provides the gift associated with the gift entitlement to the recipient. In this way, gift card related fraud may be greatly reduced as compared to conventional gift cards.

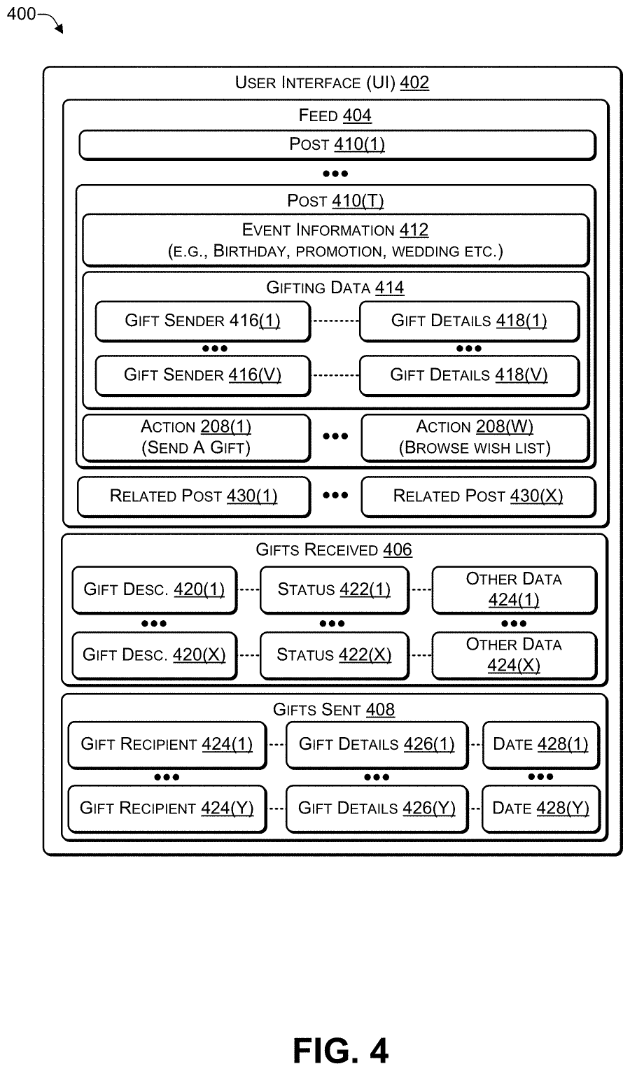

FIG. 4 is a block diagram 400 of a user interface with a feed that includes posts identifying a description of a gift, and a sender and a recipient of the gift, according to some embodiments. A user interface 402 may include a feed window 404. The user interface 402 may be part of the app 204, part of one or more of the social media sites 220, or both. The user interface 402 may include a gifts received 406 window and a gifts sent 408 window. The feed window 404 may display a portion of one or more of the social media sites 220.

The feed window 404 may include multiple posts, such as a post 410(1) to a post 410(T) (T>0). Each post, such as the representative post 410(T), may include event information 412 describing an event (e.g., birthday, promotion, engagement, wedding, or the like), gifting data 414, and related posts 430(1) to 430(X) (X>0). The gifting data 414 may identify gift senders 416(1) to 416(V) (V>0) and gift details 418(1) to 418(V) corresponding to each of the gift senders 416. The gift senders 416 may identify a sender that sent a gift to a particular recipient. The gift details 418 may include an identity of a recipient of the gift, a description of the gift, the sender's gift message 218 of FIG. 2, the recipient message 226, and other gift related details. The post 410(T) may include one or more actions, such as the actions 208(1) to the action 208(W) (W>0), that a user of the user interface 402 may perform by selecting a particular one of the actions 208. For example, the actions 208 may enable the user to use the user interface 402 to access the gifting platform 132 of FIG. 1 to browse a wish list of a recipient, send a gift to the recipient, or perform another action using the gifting platform 132. The related posts 430 may include posts related to the event identified by the event information 412 and may be related to the gifting data 414. For example, if a sender sends a gift to a recipient, then friends of the sender and/or the recipient may post comments, such as, for example, “Great gift!”, “I'm sure the recipient will make good use of that gift” or the like. The related posts 430 may be in the form of an audio file, a video file, an image file (e.g., photo), a text, or any combination thereof.

The gifts received 46 may include information about gift entitlements received by a user that is using the user interface 402. For example, the gifts received 406 may include gift descriptions 420(1) to 420(X) (X>0) that describe the gift entitlements that the user has received. Each of the gift descriptions 420 may have a status 422 indicating whether the gift entitlement has been redeemed, not redeemed, or partially redeemed. Each of the gift descriptions 420 may include other data 424. The other data 424 may include, for example, a link to a post associated with a particular gift, such as the post 410(T) to enable the recipient to playback a sender message, or other messages in the related posts. The other data 424 may include a date when the corresponding gift description 420 was sent. In some cases, the other data 424 may include an expiry date associated with the corresponding gift description 420. The recipient may be unable to redeem the gift entitlement (e.g., the gift description 420) after the expiry date.

The gifts sent 408 may include information about gifts sent by a user using the user interface 402. For example, the gifts sent 408 may include data identifying one or more gift recipients 424(1) to 424(Y) (Y>0), gift details 426, and a date 428 when the gift was sent by the user to another user.

Thus, a user interface of a gifting app, a social media site, or both may display multiple posts. Each post may include event information about a particular event associated with a member of the social media site and may include information about people that have sent a gift to a particular recipient (e.g., another member of the social media site). Each post may include details about the gift, such as a description of the gift, a gift message from a corresponding sender, recipient message from the recipient, and other information related to the gift giving. The user interface may enable a user to perform various actions, such as, for example, browsing a wish list of the recipient and sending a gift that is either (1) in the wish list or (ii) not in the wish list. Other users may be able to add posts that are related to each gift sent by a sender to a recipient. The user interface of the app may include information about which gifts the user has received from others, including a description of each gift and the status (e.g., redeemed, unredeemed, or partially redeemed) of each gift. The user interface of the app may include information about which gifts the user has sent to others, including a name of each recipient, details about each gift (e.g., gift description, cost, a name of a merchant fulfilling the gift entitlement, and the like), and the date when the gift was sent to each recipient.

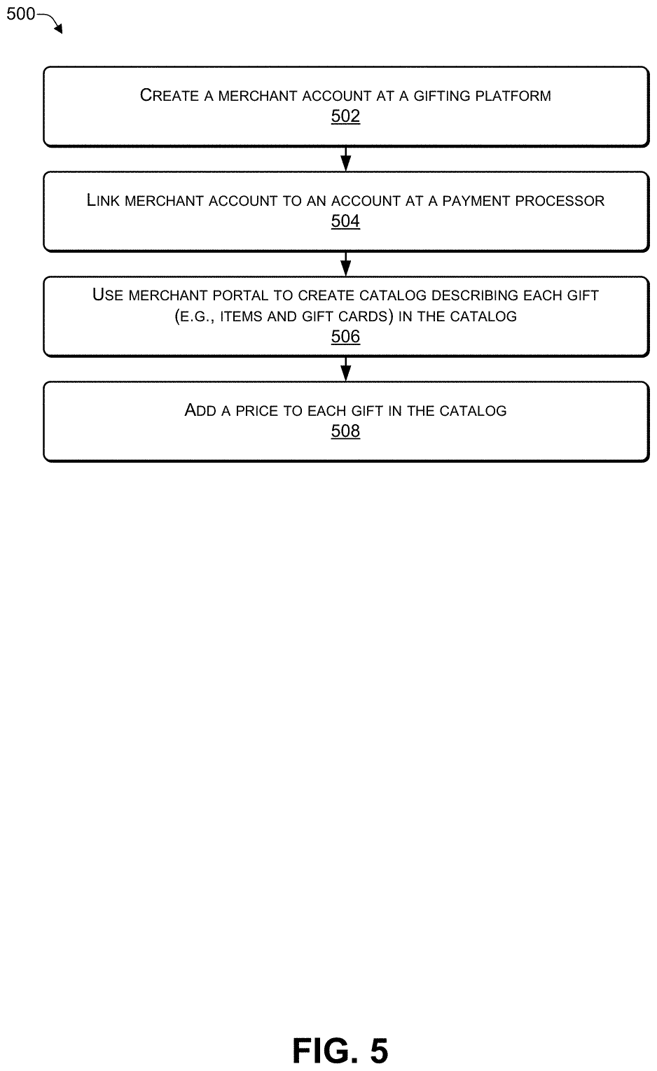

In the flow diagrams of FIGS. 5, 6, and 7, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 500, 600, and 700 are described with reference to FIGS. 1, 2, 3, and 4 as described above, although other models, frameworks, systems and environments may be used to implement this process.

FIG. 5 is a flowchart of a process 500 that includes creating a catalog, according to some embodiments. The process may be performed by a merchant device, such as the merchant device 102 of FIG. 1.

At 502, the merchant device may be used to create a merchant account at a gifting platform. At 504, the merchant device may be used to link the merchant account to an account (e.g., associated with the merchant) at a payment processor. For example, in FIG. 1, the merchant device 102(N) may be used to send the account creation message 110 to create the merchant account 112(N) with the gifting platform 134. The merchant device 102(N) may be used to send the account linking message 128 to link the merchant account 112(N) with the account 116 of the merchant at the payment service provider 118. When a sender purchases an item from the merchant's gift catalog 120, the payment service provider 118 may process the recipient's payment and deposit at least a portion of the payment into the account 116.

At 506, the merchant device may be used to access a merchant portal to create a catalog describing each gift in the catalog and a price of each gift in the catalog. For example, in FIG. 1, the merchant device 102(N) may be used to access the merchant portal 114 to create the gift catalog 120.

Thus, a merchant may use a merchant device to create a merchant account with the gifting platform and create a catalog of gift entitlements available for senders to purchase and send to recipients.

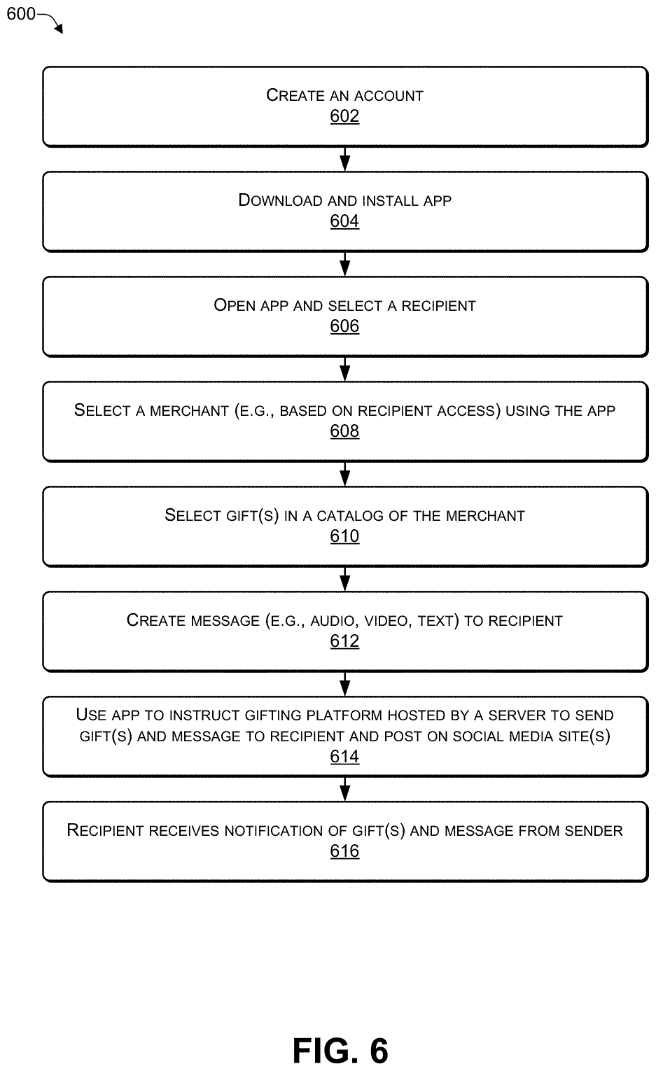

FIG. 6 is a flowchart of a process 600 that includes selecting a gift and creating an associated message, according to some embodiments. The process 600 may be performed by a user device of a sender, such as the user device 202(1) of FIG. 2.

At 602, the user device may be used to create an account. At 604, the user device may be used to download and install an application (“app”) on the user device. For example, in FIG. 2, the sender may become a member of the gifting platform 134 and use the user device 202(1) to download the app 204(1) to access the gifting platform 134. The user device 202(1) may download the app 204(1) from gifting platform 134 (or from another location, such as an app store) and install the app 204(1) on the user device 202(1).

At 606, the app may be opened and used to select a recipient. At 608, the user device may be used to select a merchant. At 610, the user device may be used to select one or more gifts in a catalog of the merchant. The merchant may be determined based at least in part on a proximity of one or more locations of the merchant to a home location or a work location of the recipient. In some cases, the merchant may be determined based at least in part on a wish list created by the recipient. For example, in FIG. 6, the sender may open the app 204(1) to access the gifting platform 134 and send the select recipient message 210 to select a particular recipient. If the recipient is one of the members 132, then the sender may select one of the members 132. If the recipient is not one of the members 132, then the sender may enable the app 204(1) to access contact information associated with the recipient that is stored on the user device 202(1) in a contacts file. The contact information may include a name of the recipient, a location of the recipient (e.g., city, zip code, or the like), and contact information, such as, a phone number (e.g., for a mobile device) of the recipient, an email address of the recipient, or both. If the recipient is a member of the gifting platform 134, then the sender may select a particular one of the members 132. If the recipient is one of the members 132 and has created a wish list, such as the wish list 216, then the sender may browse the wish list and select a particular item from the wish list. If the recipient is not one of the members 132 or is one of the members 132 but has not created a wish list, then the gifting platform 134 may automatically display merchant accounts in a particular proximity (e.g., within a predetermined distance) from the recipient. For example, if the recipient is in a particular city, then the gifting platform 134 may automatically display the merchant accounts 112 that are located in the particular city. The sender may browse the gift catalogs 120 corresponding to each of the merchant accounts 112 that are being displayed and select a particular gift entitlement (e.g., a gift description 122).

At 612, the user device may be used to create a message (e.g., audio, video, an image file (e.g., photo), text, or any combination thereof) for the recipient. At 612, the user device may be used to instruct a gifting platform hosted by a server to send selected one or more gifts and the message to the recipient and to post information about the gift, including the message, on one or more social media sites. For example, in FIG. 2, the user device 202 may be used to create the gift a message 218. The gift message 218 may be an audio file, a video file (that includes audio), an image file (e.g., photo), a text message, or any combination thereof. The sender may use the user device 202(1) to instruct the gifting platform 134 to send the selected gifts and the gift a message 218 to the recipient and to post gift info 230 that includes information about the gift and the gift message 218, on to the social media sites 220.

At 616, the user device associated with the recipient may receive a notification message regarding the one or more gifts and the message from the recipient. In some cases, the notification message may include a link to a social media site where a post describes the gift that was sent, the name of the recipient, the name of the sender, and enables playback of the message from the recipient. For example, in FIG. 1, the user device 202(R) associated with the recipient may receive the gift notification message 224 including the link to 32 to access the gift info 230 post on the social media sites 220.

Thus, a user that desires to send a gift entitlement to a recipient may download and install an app on a user device associated with the user and use the app to become a member of a gifting platform. The user may use the app to access the gifting platform and select another member as a recipient of a gift. After selecting a member of the gifting platform as a recipient, if the recipient has created a wish list, then the sender may browse a wish list of the recipient and select a gift entitlement. If the recipient is not a member of the gifting platform or has not created a wish list, then the gifting platform may display one or more merchant accounts, including gift catalogs, that are accessible to the recipient. The sender may select a gift entitlement from the gift catalogs of merchants that are accessible to the recipient. After selecting a gift entitlement, the sender may record a gift message and instruct the gifting platform to send a notification to the recipient that the recipient has received the gift entitlement and the gift message. The information associated with the gift, including the recipient, the sender, a description of the gift entitlement, the gift message, and other gift related information (e.g., the reason for the gift) may be posted on one or more social media sites. In some cases, one of the social media sites may be associated with the gifting platform. Others (e.g., friends or family members of the recipient) may view the post of the gift information and become a member of the gifting platform to send a gift entitlement to the recipient.

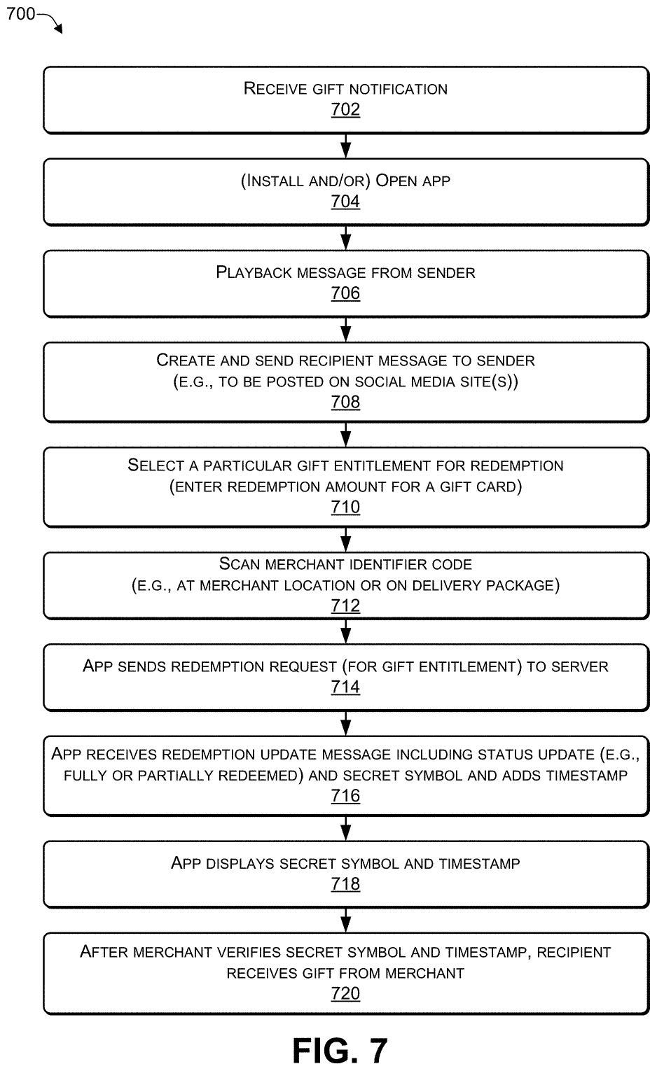

FIG. 7 is a flowchart of a process 700 that includes scanning a merchant identifier code to redeem to the recipient notification, according to some embodiments. The process 700 may be performed by a user device of a recipient, such as the user device 202(R) of FIG. 2 and FIG. 3.

At 702, a user device may receive a gift notification message. At 704, an application may automatically open in response to the user device receiving the gift notification message or if the application is not currently installed on the user device, the gift notification may include a link to download and install the application. For example, in FIG. 2, the user device 202(R) associated with the recipient may receive the gift notification 224. In response to receiving the gift notification 224, the user device 202(R) may automatically open the app 204(R) and display the gift notification 224. If the app 204(R) is not currently installed on the user device 202(R) then the gift notification 224 may include a link to 32 to download and install the app 204(R) on the user device 202(R).

At 706, the user device may playback a message from a sender of the gift entitlement. For example, in FIG. 2, in response to receiving the gift notification 224, the user device 202(R) may automatically open the app 204(R) and playback the gift message 218. To illustrate, the app 204(R) may access the post of the gift information 230 and playback the gift message 218 that is included in the post.

At 708, the user device may be used to create and send a recipient message to the sender. The recipient message may be posted to one or more social media sites. For example, in FIG. 2, the recipient may use the app 204(R) to create the recipient message 226. The app 204(R) may post the recipient message 226 as a sub-post to the gift information post 230 on the social media sites 220.

At 710, the user device may be used to open the application and select a particular gift entitlement for redemption. In the case of a gift card, a user of the user device may enter a redemption amount. For example, in FIG. 3, the recipient 324 may open the app 204(R) and select a particular gift entitlement, such as the gift description 228, that the recipient 324 desires to redeem. If the gift entitlement is a gift card, in addition to selecting the particular gift entitlement, the recipient 324 may enter a redemption amount.

At 712, the user device may be used to scan a merchant identifier code (e.g., QR code). At 714, the application may send a redemption request to a gifting platform hosted by a server. At 716, the app may receive a redemption update message from the gifting platform, including a status update to the gift entitlement and ace secret symbol. In response to receiving the redemption update message, the application may add a timestamp of a current time and date. At 718, the application may display the secret symbol and the timestamp. At 720, after an employee of the merchant verifies the secret symbol and the timestamp, the recipient may receive the gift corresponding to the gift entitlement from the merchant. For example, in FIG. 3, the recipient 324 may use the user device 202(R) to scan the merchant ID code 304. In response to scanning the merchant ID code 304, the app 204(R) may send the redemption request 308 to the gifting platform 134. The gifting platform 134 may modify the status 312 of the gift entitlement (gift description 228) and send the redemption update message 314 to the user device 202(R). The redemption update message 314 may update the status 312 of the gift entitlement (e.g., gift description 228). In response to receiving the redemption update message 314, the app 204(R) may create a timestamp that includes a time and a date identifying when the redemption update message 314 was received. The redemption update message 314 may include the secret symbol 314 associated with the merchant that will be redeeming the gift entitlement. The recipient 324 may use the app 204(R) to display the secret symbol 318 and the timestamp 322 the employee 328 of the merchant. The employee 328 may verify that the secret symbol 318 is currently associated with the merchant and that the timestamp 320 is within a predetermined time interval from a current time. After verifying that the secret symbol and timestamp are correct, the employee 328 may provide the gift 330 to the recipient 324.

Thus, a recipient of a gift entitlement may open an app capable of accessing a gifting platform, select a particular gift entitlement (and for a gift card, enter a redemption amount), and use the app to scan a merchant ID code associated with a merchant. The merchant ID code may be displayed at a location of the merchant or on merchant packaging of a delivery item. After scanning the merchant ID code, the app may send a redemption request to the gifting platform that includes the merchant ID code and information associated with the gift entitlement. The gifting platform may receive the redemption request, verify that the recipient has an account that includes the gift entitlement, and mark a status of the gift entitlement to redeemed (or partially redeemed in the case of a gift certificate). The gifting platform may send a redemption update message to the app that updates the status of the gift entitlement (e.g., redeemed or partially redeemed). The redemption update message may include a secret symbol associated with the merchant. In response to receiving the redemption update message, the app may create a timestamp that includes a time and date when the redemption update message was received. The app may display the secret symbol and the timestamp. After verifying the secret symbol and the timestamp, an employee of the merchant may provide the gift corresponding to the gift entitlement to the recipient. In this way, gift card fraud is reduced without increasing the burden on the merchant.

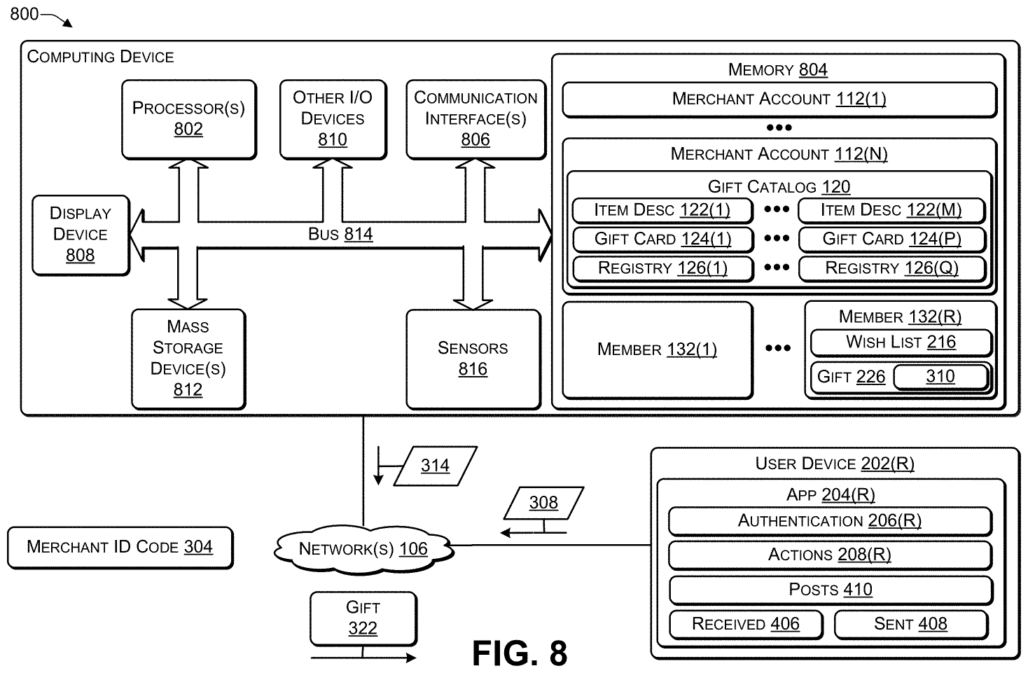

FIG. 8 illustrates an example configuration of a device 800 that can be used to implement the systems and techniques described herein, such as for example, the devices 102, 202, and the server 104 of FIG. 1. For illustration purposes, the device 800 is shown in FIG. 8 as implementing the server 104 of FIGS. 1, 2, and 3.

The device 800 may include one or more processors 802 (e.g., CPU, GPU, or the like), a memory 804, communication interfaces 806, a display device 808, other input/output (I/O) devices 810 (e.g., keyboard, trackball, and the like), and one or more mass storage devices 812 (e.g., disk drive, solid state disk drive, or the like), configured to communicate with each other, such as via one or more system buses 814 or other suitable connections. While a single system bus 814 is illustrated for ease of understanding, it should be understood that the system buses 814 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 802 are one or more hardware devices that may include a single processing unit or a number of processing units, all of which may include single or multiple computing units or multiple cores. The processors 802 may include a graphics processing unit (GPU) that is integrated into the CPU or the GPU may be a separate processor device from the CPU. The processors 802 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 802 may be configured to fetch and execute computer-readable instructions stored in the memory 804, mass storage devices 812, or other computer-readable media.

Memory 804 and mass storage devices 812 are examples of computer storage media (e.g., memory storage devices) for storing instructions that can be executed by the processors 802 to perform the various functions described herein. For example, memory 804 may include both volatile memory and non-volatile memory (e.g., RAM, ROM, or the like) devices. Further, mass storage devices 812 may include hard disk drives, solid-state drives, removable media, including external and removable drives, memory cards, flash memory, floppy disks, optical disks (e.g., CD, DVD), a storage array, a network attached storage, a storage area network, or the like. Both memory 804 and mass storage devices 812 may be collectively referred to as memory or computer storage media herein and may be any type of non-transitory media capable of storing computer-readable, processor-executable program instructions as computer program code that can be executed by the processors 802 as a particular machine configured for carrying out the operations and functions described in the implementations herein.

The device 800 may include one or more communication interfaces 806 for exchanging data via the network 110. The communication interfaces 806 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 806 can also provide communication with external storage, such as a storage array, network attached storage, storage area network, cloud storage, or the like.

The display device 808 may be used for displaying content (e.g., information and images) to users. Other I/O devices 810 may be devices that receive various inputs from a user and provide various outputs to the user, and may include a keyboard, a touchpad, a mouse, a printer, audio input/output devices, and so forth.

The computer storage media, such as memory 116 and mass storage devices 812, may be used to store software and data, including, for example, the member accounts 112 and the merchant accounts 110.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
opening, by a computing device, a software application associated with a gifting platform;
receiving a selection, by the computing device, selecting a particular gift entitlement from one or more gift entitlements available for redemption;
scanning, by the computing device, a merchant identifier code that uniquely identifies a merchant associated with the gift entitlement;
sending, by the computing device, a redemption message to the gifting platform, the redemption message comprising:
a recipient identifier identifying a recipient of the particular gift entitlement;
a gift identifier identifying the particular gift entitlement; and
a device identifier that uniquely identifies the computing device;
receiving, by the computing device, a redemption update message from the gifting platform, the redemption update message comprising a secret symbol;
generating, by the computing device, a timestamp comprising a current time and date; and
displaying, by the computing device, the secret symbol and the timestamp to enable an employee of a merchant associated with the particular gift entitlement to verify the secret symbol and the timestamp and provide a gift corresponding to the gift entitlement.

2. The method of claim 1, further comprising:
in response to receiving, by the computing device, a gift notification message from the gifting platform indicating that a user of the computing device has received a gift entitlement from a sender:
automatically opening the software application;
automatically selecting a link in the gift notification message to display a post on a social media site, the post comprising:
a sender name of the sender of the gift entitlement;
a recipient name of the user of the computing device;
a description of the gift entitlement; and
a sender message created by the sender; and
automatically playing back the sender message.

3. The method of claim 2, wherein the sender message comprises at least one of:
a video message;
an audio message;
an image message; or
a text message.

4. The method of claim 1, further comprising:
in response to receiving, by the computing device, a gift notification message from the gifting platform indicating that a user of the computing device has received a gift entitlement from a sender:
determining that the software application is not installed on the computing device;
automatically downloading the software application;
automatically installing the software application on the computing device;
automatically opening the software application;
automatically selecting a link in the gift notification message to display a post on a social media site, the post comprising:
a sender name of the sender of the gift entitlement;
a recipient name of the user of the computing device;
a description of the gift entitlement; and
a sender message created by the sender; and
automatically playing back the sender message.

5. The method of claim 1, further comprising:
in response to receiving a redemption update message from the gifting platform, updating a status of the particular gift entitlement from unredeemed to one of redeemed or partially redeemed.

6. The method of claim 1, wherein based on determining that the gift entitlement comprises a gift card:
selecting the particular gift entitlement comprises:
selecting the gift card entitlement; and
receiving a redemption amount; and
the redemption update message updates a remaining balance of the gift card by deducting the redemption amount from a current balance of the gift card.

7. The method of claim 1, wherein:
the secret symbol is selected by the merchant and is associated with the merchant for a predetermined period of time specified by the merchant.

8. A computing device comprising:
one or more processors; and
one or more non-transitory computer readable media storing instructions executable by the one or more processors to perform operations comprising:
initiating execution of a software application associated with a gifting platform;
receiving a user selection selecting a particular gift entitlement from one or more gift entitlements available for redemption;
scanning a merchant identifier code that uniquely identifies a merchant;
sending a redemption message to the gifting platform, the redemption message comprising:
a recipient identifier identifying a recipient of the particular gift entitlement;
a gift identifier identifying the particular gift entitlement; and
a device identifier that uniquely identifies the computing device;
receiving a redemption update message from the gifting platform, the redemption update message comprising a secret symbol;
generating a timestamp comprising a current time and date; and
displaying the secret symbol and the timestamp to enable an employee of a merchant associated with the particular gift entitlement to verify the secret symbol and the timestamp and provide a gift corresponding to the gift entitlement.

9. The computing device of claim 8, wherein:
the software application displays a feed from a social media site associated with the gifting platform.

10. The computing device of claim 8, wherein:
the merchant identifier code comprises a quick response (QR) code.

11. The computing device of claim 8, wherein:
the gift entitlement is selected by a sender from a wishlist created by a user of the computing device, and
the wishlist is stored in an account of the user on the gifting platform.

12. The computing device of claim 8, wherein:
the gift entitlement is selected by a sender from a merchant catalog created by a merchant;
the merchant catalog is stored in a merchant account of the merchant on the gifting platform; and
the merchant is selected in part based on a proximity of at least one location of the merchant to a user of the computing device.

13. The computing device of claim 8, wherein the device identifier comprises one of:
an International Mobile Equipment Identity (IMEI) number;
a media access control (MAC) address; or
a serial number.

14. The computing device of claim 8, wherein based on determining that the gift entitlement comprises a gift card:
selecting the particular gift entitlement comprises:
selecting the gift card entitlement; and
receiving a redemption amount; and
the redemption update message updates a remaining balance of the gift card by deducting the redemption amount from a current balance of the gift card.

15. One or more non-transitory computer-readable media storing instructions executable by one or more processors to perform operations comprising:
initiating execution of a software application associated with a gifting platform;
receiving a user selection selecting a particular gift entitlement from one or more gift entitlements available for redemption;
scanning a merchant identifier code that uniquely identifies a merchant;
sending a redemption message to the gifting platform, the redemption message comprising:
a recipient identifier identifying a recipient of the particular gift entitlement;
a gift identifier identifying the particular gift entitlement; and
a device identifier that uniquely identifies the computing device;
receiving a redemption update message from the gifting platform, the redemption update message comprising a secret symbol;
generating a timestamp comprising a current time and date; and
displaying the secret symbol and the timestamp to enable an employee of a merchant associated with the particular gift entitlement to verify the secret symbol and the timestamp and provide a gift corresponding to the gift entitlement.

16. The one or more non-transitory computer readable media of claim 15, further comprising:
in response to receiving, by the computing device, a gift notification message from the gifting platform indicating that a user of the computing device has received a gift entitlement from a sender:
automatically opening the software application;
automatically selecting a link in the gift notification message to display a post on a social media site, the post comprising:
a sender name of the sender of the gift entitlement;
a recipient name of the user of the computing device;
a description of the gift entitlement; and
a sender message created by the sender; and
automatically playing back the sender message.

17. The one or more non-transitory computer readable media of claim 15, further comprising:
in response to receiving a redemption update message from the gifting platform, updating a status of the particular gift entitlement from unredeemed to either redeemed or partially redeemed.

18. The one or more non-transitory computer readable media of claim 15, wherein based on determining that the gift entitlement comprises a gift card:
selecting the particular gift entitlement comprises:
selecting the gift card entitlement; and
entering a redemption amount; and
the redemption update message updates a remaining balance of the gift card by deducting the redemption amount from a current balance of the gift card.

19. The one or more non-transitory computer readable media of claim 15, wherein:
the gift entitlement is selected by a sender from a wishlist created by a user of the computing device, and
the wishlist is stored in an account of the user on the gifting platform.

20. The one or more non-transitory computer readable media of claim 15, wherein:
the gift entitlement is selected by a sender from a merchant catalog created by a merchant;
the merchant catalog is stored in a merchant account of the merchant on the gifting platform; and
the merchant is selected in part based on a proximity of at least one location of the merchant to a user of the computing device.
